(19) United States
(12) Patent Application Publication
(10) Pub. No.: US 2003/0149580 A1
(43) Pub. Date: Aug. 7, 2003

(54) Customized interaction with computer network resources

(76) Inventors: Toby Moores, Leicester (GB); Mark Hilton, Leicester (GB)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/220,111

(22) PCT Filed: Mar. 1, 2001
(86) PCT No.: PCT/GB01/00877

(30) Foreign Application Priority Data
Mar. 1, 2000 (GB) 0004993.2

(51) Int. Cl. G06F 17/60

(52) U.S. Cl. 705/1

(57) ABSTRACT

A user describes himself or his interests by selecting at least one of a predetermined set of profiles, which reflect human characteristics. The selected profile(s) can be used when interacting over a communication network (e.g. the Internet) (7) to facilitate being directed to appropriate remote information or to appropriate other users. Information about the activities of many users, such as information about Internet usage, can be gathered by a central server (19) and collated to compile statistical information in relation to their respective selected profile(s).

### FIELD OF THE INVENTION

The present invention relates to methods and systems in which the interaction between one or more human users and computing apparatus is enhanced according to the users' characteristics and/or present interests. The invention further relates to computer program products, such as products stored on a recording medium, carrying program instructions which are readable by a computing apparatus to cause the computing apparatus to carry out a method according to the invention.

### BACKGROUND OF THE INVENTION

The amount of information which is available over the Internet is growing immensely quickly. Even in 1998 it was estimated that the Web had 20 million “places” (defined as specific Web pages containing real content, such as main pages on a site). The rate of growth is out of proportion to the ability of people to locate information which is of interest to them. A keyword search using a search engine such as AltaVista or HotBot may return literally millions of hits. By contrast, a search engine such as Yahoo permits searching in more depth but is only able to access a small percentage of the information available, and requires labor-intensive indexing.

In fact, many of the sites on the web are of little intrinsic interest, and merely impede the search for valuable content. To address this problem, the technique of “Collaborative filtering” has been proposed which attempts to capitalize on a key resource: the knowledge accumulated as different people find and access documents and form opinions of them. Examples of such features are the writing style and “readability” of pages. In collaborative filtering techniques, users are given access to others' prior experience with an information source. Collaborative filtering enables public-spirited users to help later users of the Internet. Alternative techniques permit a single user to influence the pages presented to him (e.g. by a search engine) so as to bias their selection towards his interests. This is done by constructing a profile of the user, and filtering the search results using the profile (the term “filtering” is used herein to mean either or both of (i) actually excluding results which do not conform to a criterion (e.g. based on a profile), or (ii) ordering the results of a search such that results which do not conform to the criterion are very substantially lowered in the list, e.g. their “score” which determined their position in the list may be lowered). In principle, the profile could be generated by completing a detailed questionnaire, but this is laborious and users are nervous of how the detailed information about themselves may be used once they transmit it. Therefore, in practice, the profile is built up automatically.

For example, the Letizia system (“Autonomous Interface Agents” by H. Lieberman, Proceedings of CHI '97) records the URLs chosen by a user and summarises the pages to compile a profile of the user's interests. A simple keyword-frequency information retrieval measure is used to analyse pages. An agent (that is to say a program operating on behalf of the user, but not under his control) continually searches Web pages which are “nearby” the user's current position in parallel with the user's browsing activity, and presents an independent window in which the agent shows pages thought likely to interest the user.

The above systems all suffer from a number of disadvantages.

Firstly, there is the problem (“cold start”) that the first time a user uses the system it has not yet had the chance to accumulate data about him, and so is ineffective in guiding his search.

Secondly, there is a real concern about privacy, since the profile built up may be sensitive (e.g. in the case that the user is researching a particular topic in secret) or embarrassing (e.g. in the case that the sites read by the user relate to his sexuality).

Thirdly, the accumulation of the profile, and its use, is computationally expensive.

Fourthly, the interests of a user change with time (the problem of “me right now”). A person who during the week is searching for business information, may at weekends look for recreational information. Search interests also change abruptly, since a user may stop looking for information on a first topic as soon as he has found the information he required, and begin searching on a second topic. Also, without the knowledge of the searching system, a single device (e.g. terminal) may be used by different individuals with different interests. A “cookie” which is used to keep an accumulated user profile cannot cope with such changes. Furthermore, if the system is attempting to help a user to find sites related to an incorrect interest (e.g. a previous interest, or the interests of another user), the system may actually obstruct the user from finding sites related to their new interest. There is thus a “switching cost” associated with changing interests.

### SUMMARY OF THE INVENTION

The present invention seeks to provide a system for characterising the present interests of a user.

In general terms, the present invention proposes that a set of profiles is defined. Each profile reflects one or more human characteristics, e.g. describing an individual or their interests or mood. A user describes himself at any time by using a computer device to select at least one of the profiles (if more than one profile is selected they may optionally each be given a weighting). The user then interacts with his or her own computer device, or uses the computer device to communicate over a communication network, in accordance with to the selected profile(s).

The selection of the profiles is preferably performed using selection software running within, but otherwise separate from, the operating system of the computer device. Note that this is preferably separate from the self-identification the user performs at the time of log-in to identify himself to the operating system.

In a first case, each of the selected profile(s) may be associated with a respective set of one or more of computer resources, e.g. web pages or URLs, so that when a user has selected the profile(s) he is able to choose from the associated resources. Preferably, the computer resources are remote resources accessible using the communication network, e.g. by means of respective location data stored for each resource.

The set of associated resources associated with a given profile may include resources which were generated from previous actions by the user. For example, they may include resource(s) which the user has specifically chosen to associate with each of the profiles (i.e. a bookmarking process). Furthermore, they may include resource(s) accessed by the user at a previous time at which the same profile was selected (i.e. each of the profiles is associated with a “history” function).

Alternatively or additionally, the set of resources associated with a given profile may include resource(s) generated from previous actions by other users. For example, a plurality of users using different browsers may be provided with the same set of predetermined profiles from which to select. The resources accessed by the browsers when one or more of the profiles are selected are collected and transmitted to a central server of system which accumulates and collates them, so as to derive a set of resources with a high statistical association with profiles and for each resource location information which allows the resource to be accessed. The set of resources may, for example include a list of sites associated with the profile (e.g. sites of scientific interest in the case of the scientist profile) and the location information is the addresses of the sites. Any given user who has selected one or more of the profiles may be empowered to access the resources associated with those profiles; as far as he is concerned, the set of resources associated with each of the profiles is predetermined.

Whether the actions are performed only by a single user or by multiple users, any of those actions may be accompanied (e.g. followed) by a second respective action to input a judgement of the resource. For example, there may be a predetermined set of judgements (e.g. “Easy to understand”, “Hard to understand”) from which the user may make a selection. A record is stored of the judgement and of the at least one selected profile of that user at that time, so that statistics can be accumulated in relation to the site, e.g. to derive a statistic that users who have selected a “teenager profile” tend to find a certain site hard to understand or dull. In the case that there are multiple users, this statistical judgement may be included in the collation, such that sites which, in relation to users' selected profiles, have a statistically low rating, are excluded from the set of resources associated with those profiles. Additionally, users may be able to record more detailed (e.g. typed by them) comments, which are stored in relation to their respective selected profiles; these comments may be supplied, e.g. on request, to future users having similar selected profiles.

In a second case, data characterising the selected profile(s) may be transmitted when interacting over a communication network (e.g. the Internet) with a remote computing apparatus (e.g. server), to modify interaction with the remote computing apparatus. For example, information specifying the selected profiles may be transmitted to remote servers in combination with an instruction which causes the server to return information to the user's computer for display, and the server may be arranged to perform the instruction to the user in accordance with the specified profile(s). Thus, the profiles provide a protocol orientated to human characteristics for interacting with a remote computer apparatus. Alternatively or additionally, the information specifying the selected profiles may be used in operation(s) by the remote server other than to process the instruction (i.e. “unsolicited actions”), such as to determine which advertising material the user will be shown in combination with any information the user has specifically requested, and/or such as the basis of a investigation by the website of the usage made of it by different sorts of users. For example the website may retain (e.g. as many user access it over a period of time) a record of the selected profile(s) of the users (e.g. and also of the requests the users make while the profile(s) are selected); this information may be collated later (preferably automatically, or at least semi-automatically) to suggest to the operator of the website improvements which could be made to better match the profiles of the users.

The concept of a set of predefined computer resources associated with each selected profile, and the concept of interacting with remote computing apparatus based on selected profile(s), each overcome or reduce the problem of cold start discussed above. Similarly, a user may reselect the profiles upon his interests changing, avoiding the “me right now” problem. Note that these two concepts, and the preferable features associated with them, are freely combinable so that once the user has selected profile(s) he obtains both a set of resources and a means for enhanced interaction with those and other resources.

Furthermore, since the user profile(s) are selected by the user, he can ensure that they represent only those areas of his interest which he is willing to make public.

Examples of possible human characteristics include, for example, interest in a particular human activity, such as sport, music; a knowledge of a specialist subject, such as accountancy or law; a lifestyle, such as whether an individual is single, married, has or has not got children, etc; a sexual orientation; a racial origin; a political viewpoint; a religious affiliation; an appearance (e.g. hair colour); a circumstance (e.g. salary level, or disability status); a gender; a geographical location, e.g. country of residence; an age group; or a mood. A single predefined profile may correspond to just one such characteristic or a combination of characteristics. In principle, the profile might include a large number of characteristics, so that it approximates to a true human being. Thus, for example, a single profile might have the characteristics of a well-known personality, such as a celebrity, a historical character or a fictional character. As in the case of human beings, the profile data may include a weighting of human characteristics. In another analogy, a given profile may approximate to the editorial policy of a newspaper or magazine.

If at any time a user selects more than one profile, the user may give each profile a weighting. For example, if a user is interested at any moment in sport, and secondarily in financial aspects of sport, then he may choose a sporting profile and an accounting profile, weighting the former more heavily than the latter. The set of favourites presented to the user may be a sum of the favourites from the two or more selected profiles, e.g. with any duplications excluded.

Since the profiles from which the user selects are predefined, information about the activities of a plurality of users (all of whom are selecting from the same set of predefined profiles), such as information about their Internet usage, can be gathered and collated (preferably automatically, or at least semi-automatically) on the central server in relation to their respective selected profiles, to form statistical information in a manageable format, in a demographic space defined by the profiles. Such records, accumulated from plurality of users can be used to identify correlations between the selected profiles and the properties of the accessed data files. Thus, it may readily be found that users of a certain age frequently access a certain site, or a site having a certain property (e.g. containing a certain keyword). This information may be used to make the site more suitable for that sort of user, to add links or advertising to it suitable for that sort of user. Thus could be done dynamically (in real time) and/or when the site is redesigned.

It is not necessary to the invention that the profiles are static. For example, the organisation which determines the plurality of profiles from which each user selects may add (or remove) profiles, for example to represent a new well-known personality, or to reflect a new human characteristic (one not previously used in defining the profiles). This updating may for example be performed if the collated statistical data indicate that two profiles are usually used in common: in this case, the profile protocol can be simplified by defining a new profile combining the human characteristics of those two existent profiles.

Furthermore, the user may be permitted to vary the properties of the profiles. In particular, the user may be permitted to create new profiles, e.g. by a selection from a predefined palette of attributes and/or by a selection of keywords to be associated with the new profile. The profile so defined by a single user may be added to the set of predefined profiles from which that user selects in future, for example so that that user may use the new profile for their personal use as a point of reference for histories or bookmarks as described above. Alternatively or additionally, the user may make this profile available to other users, for example by transferring it to the operator of the central server. If the operator approves the new profile then it may be added to the profiles from which other users select and which remote computer apparatus is arranged to recognise.

Furthermore, especially in the context of a user using selected profiles to communicate with remote computing apparatus, the user may at any time select (or de-select) one or more supplementary properties, e.g. from a predetermined list of properties, which are temporarily associated with the selected profiles. Such properties are analogous to a “mood”.

After the central server or another computing apparatus has received information that a given user has in the past selected certain profiles (the central server not only receives this information but also preferably information about how often each user selects each of the profiles), the server or other apparatus may in the future occasionally transmit to the user data relating to the selected profiles, e.g. by email.

This transmission may be carried out in a way which is in accordance with a “personality” of the profile. For example, any one or more of the profiles may be associated with an index of “pushiness” and if the transmission is triggered by the fact that the user has selected such a profile, the transmission may be designed with that degree of pushiness.

Definitions

In this document, the term “resource” is used here to include both sites and pages of the world wide web, and also data files which are part of any other local or distributed network. Thus, it includes files of a proprietary network, such as an intranet.

The term “device” is used in this document to include any device having a processing and/or information interface function, such as computer terminals, PCs, Macs, televisions (e.g. TV remote control devices), mobile telephones, voice activated devices, and the like. In cases in which a user interacts with a first device (such as a terminal) which is in constant contact with a second device (such as an ISP), the two devices may be regarded as a single device for the purposes of the invention.

The term “computing apparatus” is used here to include any apparatus having a processing function. In the context of the internet, a “computing apparatus” may be a server, or any other server-side device, while the user is the client. Thus, the terms “user” and “computing resource” are equivalent respectively to “client” and “server”.

The disclosure of all the documents referred to herein is incorporated by reference.

### BRIEF DESCRIPTION OF THE DRAWINGS

An embodiment of the invention will now be described for the sake of illustration only with reference to the accompanying figures in which:

FIG. 1 shows schematically interaction between a user and a plurality of servers in an embodiment of the invention;

FIG. 2 shows schematically interaction between the user and central server of the embodiment of FIG. 1;

FIG. 3 shows schematically a record within the central server of FIG. 1 defining a profile for use in the invention; and

FIG. 4, which is composed of FIGS. 4(a) to 4(g), shows what is displayed to a user of the embodiment of FIG. 1.

### DETAILED DESCRIPTION OF THE EMBODIMENTS

FIG. 1 shows schematically a distributed system employing the present invention. In this embodiment the user (the client) employs a computer device including a browser program 1 which runs on the user's computer device (not shown explicitly). The browser program 1 operates in conjunction with an extension 3 to the browser program. The extension 3 permits the user to select one of a number of profiles which will be described in the following as “buddies”. As discussed in detail below, the extension 3 causes the user's computer system to display a set of buddies which the user has selected (the so-called “active buddies”), and also permits the user to revise the selections.

The user's computer system further includes a database 5, e.g. a memory disk, which describes the set of buddies from which the user may select. Each buddy has a set of attributes which are those aspects of it which distinguish it from other buddies. Attributes include, but are not limited to:

1) Appearance: the buddies visual, auditory or tactile representation to the user.

2) Behaviour: the manner in which a buddy responds to events generated by the user or a computer system.

3) Parameters which are used to tailor the function of external computing apparatus, including short-term preferences such as location, mood and time-of-day, and long term preferences such as subject areas of interest. The subject identifiers may be keywords associated with the subjects, but alternatively or additionally they may include identifiers such as those in the Dewey Decimal System which are independent of English words. For example, parameter “100” may be sport, parameter “101” may be sportswear, parameter “102” may be soccer, etc.

4) Knowledge: the information which a given buddy gathers by direct interaction with the user and/or aggregated data gathered from the interactions of that buddy with many users. This may include (a) a list of URLs which have been visited by the user while the buddy has been active, (b) a list of documents viewed or edited while the buddy has been active, (c) a list of URLs which the user has explicitly associated with the buddy (“bookmarks” or “favourites”), (d) a list of URLs which have been generated from the most popular locations visited or associated with the buddy.

Attributes may alternatively be classified as follows:

1) Those which exist to encourage human engagement.

2) Representation features which are clues to the parameters of the buddy. For example, a buddy whose parameters reflect an interest in financial business affairs might have the visual and audio representation of a serious, soberly dressed businessperson.

3) Attributes which may be varied temporarily by the user to custom the buddy, such as geographical location, goals (e.g. browsing, searching, watching) and mood (e.g. bored, occupied, outgoing, quiet).

4) Those which may be varied permanently by the user to cause the buddy to reflect his long-term self, such as gender, ethnic origin, language and culture.

5) Those which may vary dynamically according to CB usage. For example, the behaviour of a buddy might change to reflect the number of users who have made the buddy active at any point in time; a more popular buddy might behave in a more animated fashion.

Attributes may occur in more than one of the above groups. For example, a buddy which has a particular interest in women's issues may present an appearance likely to encourage humans with the same interest to choose and make active that buddy.

The above classifications of attributes are not the only possible ones. Another is into attributes which are “base” and those which are “local”. Base attributes are those which are fixed values which are common to all instances of a given buddy among all users. Local attributes are those which may be temporarily or permanently modified from the base value so that the buddy reflects his current self. For example, a gender-neutral buddy might be marked as female by a female user.

As shown in FIG. 1, the browser 1 communicates using a communication network 7 (e.g. the worldwide web). In the case that the browser 1 uses the communication network 7 to initiate communication with a remote server, the browser 1 does this by transmitting an instruction 9 which is divided into a header 13 and a body 11. The header 13 contains profile data (“buddy data”) defining which buddies the user has selected and with what weightings, and additional data specifying settings of some or all of the local attributes.

The figure indicates schematically that the user's computer system is in communication via the communication 7 with three servers 15, 17, 19. Server 15 represents one of a large number of servers which are presently known on the internet and which are not configured to operate in accordance with the terms of the present invention.

By contrast, server 17 (one such server is shown, but preferably a plurality of such servers may be reached via the communication network 7) is configured to operate within the terms of the present invention. Server 17 includes two databases 21, 23. Database 21 is for storing properties of all the set of buddies which users may select. Database 23 is for storing a log file which records instructions received from users together with the corresponding buddy data.

The central server 19 is provided by an operator of the embodiment, and includes a database 25 having an authoritative definition of the buddies. The server 19 may be queried by the server 17 (e.g. on a periodic basis) to update the information stored in the database 21. This system is more efficient than an alternative possible embodiment in which the server 17 does not include the database 21, and instead interrogates the server 19 whenever it receives an instruction 9.

We will now describe the use of the system shown in FIG. 1. To begin with the user operates his own computer device. The program extension 3 displays all of the available buddies from the database 5 and the user selects one or more buddies from the set, thus making them active. The selection may be done using a keyboard, a mouse or any other controls. The user uses the program 3 to set any of the local attributes of the buddies.

Once the buddies are selected, the user uses browser 1 and extension 3 to generate the instruction 9 and transmit it to one of the servers 15, 17, 19. Note that although the instruction 9 contains the buddy data, it does not need to include the full definitions of the buddies. The fact that instruction 9 has been generated, and the one or more buddies selected at that time, are written together into the database 5.

If the instruction 9 is directed to the server 15 which is not empowered to comprehend the buddy data, the server 15 simply ignores this data and processes only portion 11 of the instruction 9 in the usual way. That is, the server 15 responds to the user's browser program 1, which displays the information received from the browser 15.

If the instruction 9 is directed to the server 17, then the server 17 receives the instruction and processes the buddy data 13. For each buddy which is specified by the buddy data 13, the server 17 retrieves the definition of the buddy from the database 21. In a case in which that information is out of date, however, the server 17 requests the updated definition of the buddy from the server 19 by passing the server 19 an ID of the buddy. For efficiency, the server 17 may ask for the parameters of all the buddies in a single request to the server 19, so that all profiles are updated not just the one specified by the buddy data 13.

The server 17 generates a response to the instruction 9 based on the set of buddies specified by the profile data 13, and in particular their one or more “parameters”.

To give a specific example, the server 17 may be an online magazine site where there are articles about numerous subjects. When the instruction 9 arrives to request information from that site, the server 17 is able to match the subject identifiers of the buddies specified by buddy data 13 to the subject identifiers of articles, to present to the user a front page which is more relevant to the interests of the user.

In a second example, the server 17 may be an online shopping site. By evaluating the subject identifiers, gender and age parameters of the buddies specified by the data 13, the site can offer a set of products or special offers tailored to the user. Alternatively or additionally, the available products may be sorted or filtered so that those most interesting to the user are presented first.

In a third example, the server 17 may operate a search engine (e.g. to search for pages or sites of the world wide web) and the buddy definitions in the database 21 may contain information which can be used to improve the chance that the search discovers information relevant to the selected profile. For example, stored data for each profile may include at least one keyword associated with that profile, so that the search can use that keyword(s), e.g. in combination with keywords specified by the user and included in the body 11. The usage of the keyword specified by the user and the retrieved keywords may be different, however, for example such that the search demands that the keyword specified by the user is present in the site of interest, but the keywords retrieved from the database are used in a scoring of the results in the search to influence (or determine) the order in which those results are presented to the user. For example, the scoring of a given site may be calculated as a sum over a measure of the pages' content's relation to the interests expressed by the selected profiles (e.g. a sum over the profiles selected by the user (multiplied by the weightings of the profiles, if any) of the sum over the keywords retrieved from the database for those profiles (optionally multiplied by respective weightings for those keywords) of a number representing the incidence of those keywords in the sites).

In a fourth example, the server 17 may operate a “chat room”: that is a facility in which a plurality of users are paired automatically for communication. For example, the operator of a chat room might receive from a plurality of users respective requests for a chat, each request being associated with a respective set of buddy data. The operator of the site may then pair the users off (or otherwise divide them into groups) based on the profile data, for example so that so far as possible (e.g. according to a predefined optimisation algorithm) all pairs of users have maximally similar profile data, or even so that pairs of users have maximally dissimilar profile data (e.g. in the case that the function of the chat room is to provoke argument).

Turning to FIG. 2, the interaction between the user's computer and the central server 19 is shown in more detail. In particular, the central server 19 is shown as not only accessing a database 25, but also a second database 29 for storing database downloaded from the user's database 5. Furthermore, the server 19 is shown as including a portion 27 for organising the communication between the network 7 and the database 25 (for example to answer the requests made by the server 17), and a portion 31 for updating the database 25 based on the database 29.

In use the browser 1 accumulates data associated with selected buddies in the database 5 as described above. Occasionally the browser 1 communicates via the communication network 7 with the server 19. This may be due to an explicit instruction by the user to communicate with the server 19, such as to obtain information from that server, but alternatively it may be triggered by the program 3 to occur automatically, for example without the user's knowledge. When the connection between the user's computer system and the server 19 is established, the user's computer system transmits a signal 33 to the server 19 containing the data in database 5 indicating the instructions which the user's computer device has issued recently and the buddies which were active at those times. For example, the signal 33 may indicate which sites the user visited while each of the buddies was selected. The server 19 stores this information in the database 29.

Additionally, the server 19 checks the date and time since the computer system of that user last connected to the server 19, and if there are new buddies or if there is updated information for existing buddies, the server 19 transmits that information from database 25 to the computer system of that user so that the database 5 is updated.

Periodically, the program 31 processes the database 29 and according updates the parameters and other information in database 25. For example, the database 25 may record a list of favourite sites associated with each buddy. If the program 31 observes statistically that the sites which users with a certain buddy selected visit with most frequency is different from the set of favourites associated with that buddy in the database 25, then the program 31 updates the set of favourites in the database 25 associated with that buddy so as to be equal to the sites which are statistically most associated with that buddy.

Note that because the information accumulated on the server 19 is statistical in nature, the privacy of the users is not compromised. Furthermore, because the same buddy protocol is used throughout the system the collating of the statistical information may be performed in a “clean” way. Even though a given user may always use buddy A in combination with buddy B, the data submitted on behalf of a large number of users each of whom use buddy A in combination with other of the buddies means that statistically the information gathered from such users gives good information about the buddy A. Alternatively, or additionally, the server 19 may intentionally accumulate data concerning Internet usage by users who have selected a particular combination of two (or more) buddies.

The data stored in database 29 is of considerable commercial value, since it identifies which demographic group (categorised according to the buddy protocol) visits which sites or sorts of sites. Thus, the information may be used, for example, as the basis of for placing appropriate advertising on these sites, or for calculating the advertising revenue the sites deserve for accepting this advertising.

The record 100 of a particular buddy in the database 25 is as shown in FIG. 3. It includes: a header 101 naming the buddy (e.g. by an ID); a list of subject identifiers 103 associated with the buddy (optionally each identifier may be associated with a number, indicating the importance of that subject to the buddy); a section 105 which includes personality properties 102, 104, 106, 108 and for each personality property a real valued number (shown in FIG. 3 schematically as a point a specific distance along a line); and a list 107 of favourite sites (computer resources) associated with the buddy. For example, in the case of the scientist buddy, the list of sites 107 may include sites of scientific interest.

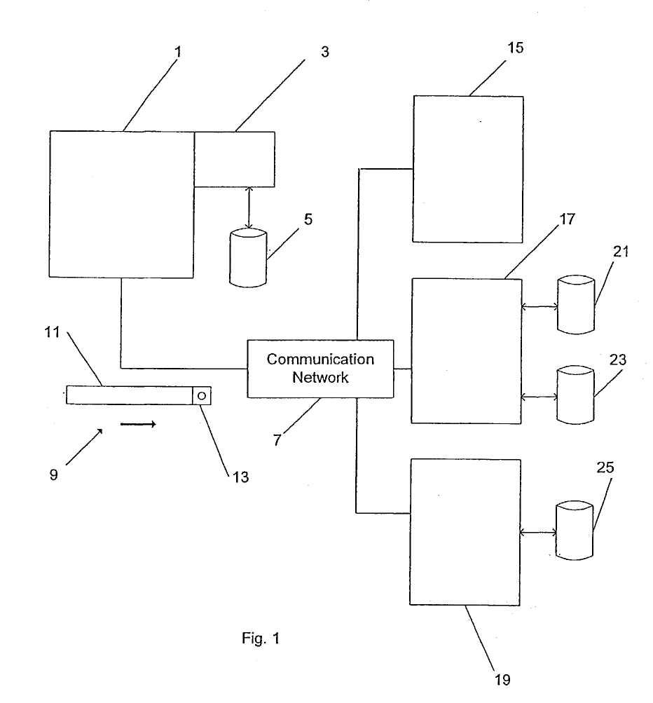

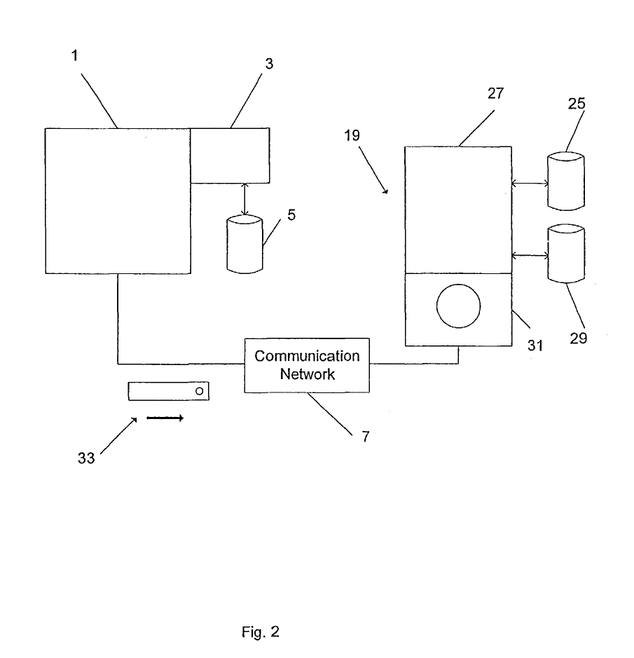

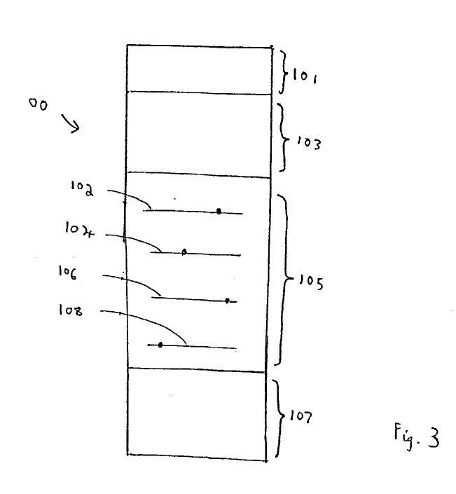

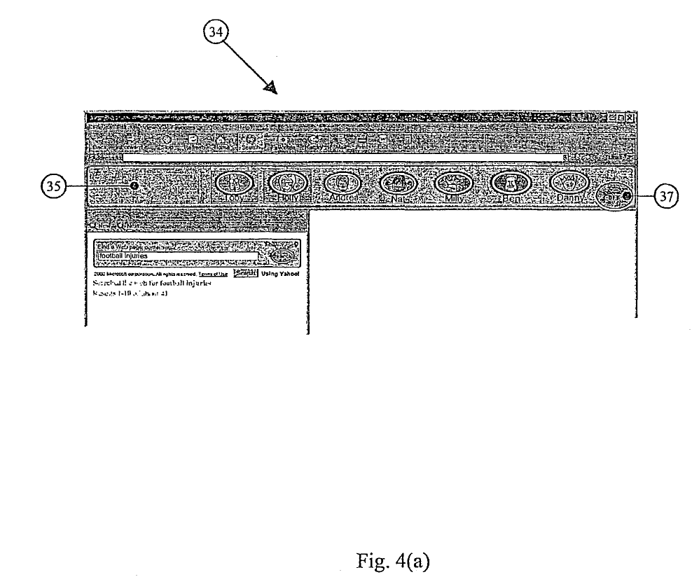

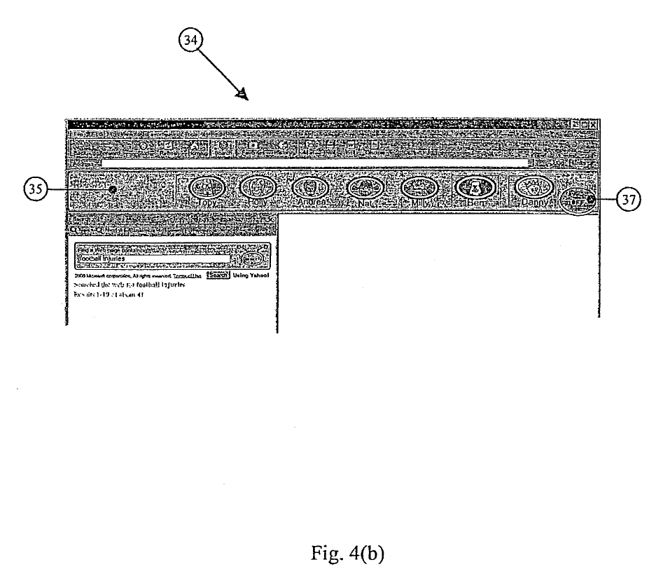

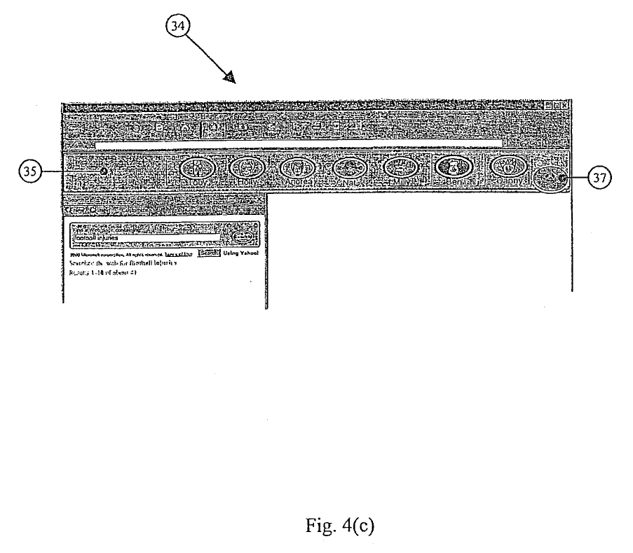

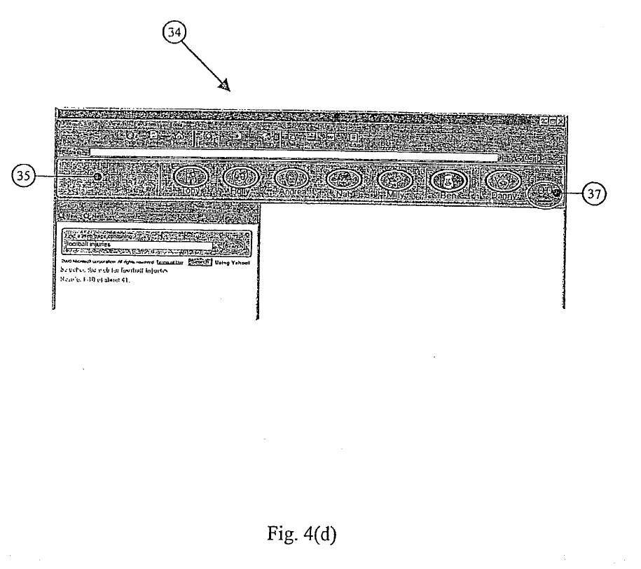

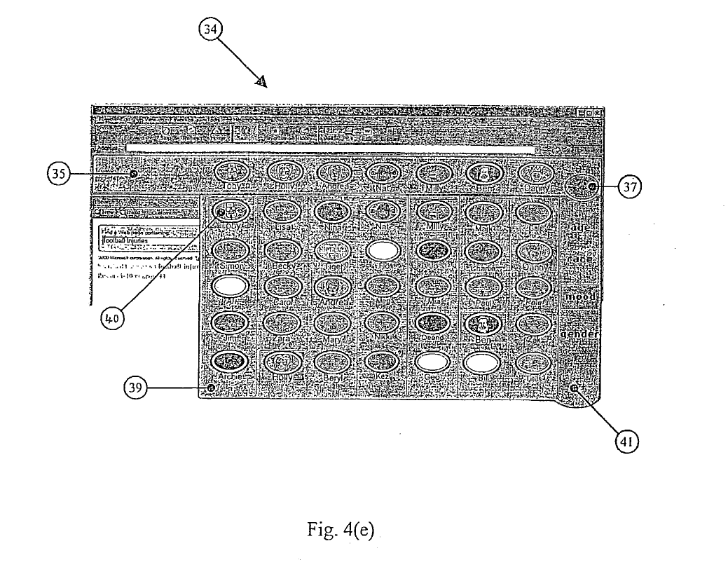

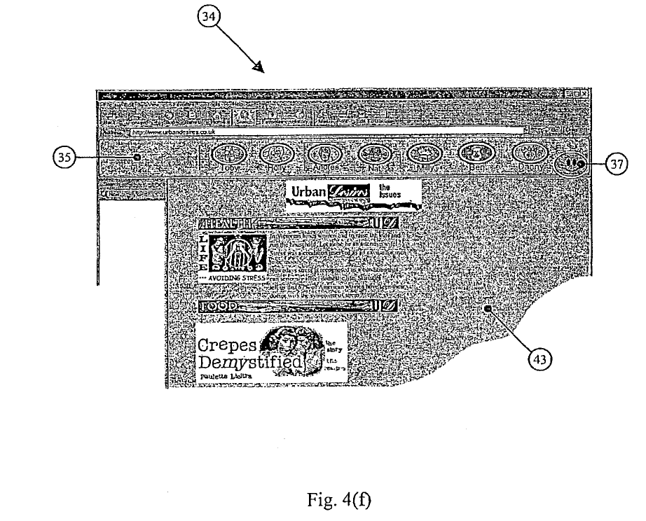

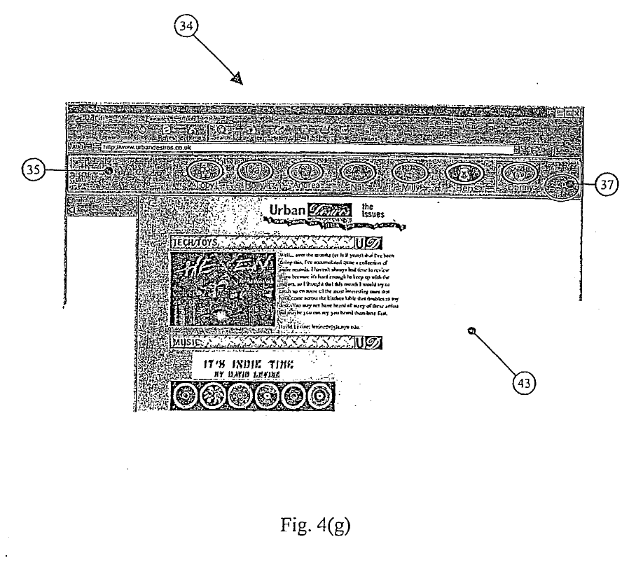

Turning to FIG. 4, a graphical use of interface (GUI) suitable for use in the present invention is shown. The interface includes a window 34 which is a conventional browser, but comprising an additional section 35. The section 35 shows seven icons “Toby”, “Holly”, “Andrea”, “Nat”, “Milly”, “Ben” and “Danny”. Each of these icons represents a respective buddy. Furthermore the section 35 of the window 34 comprises a clickable button 37. Each of the seven buddy icons may be clicked to toggle it on/off. Thus, in FIG. 4a the two buddies “Toby” and “Holly” are toggled on, while the other five buddies are toggled off. In FIG. 4(b), the user has clicked on the four icons Toby, Holly, Ben and Danny so as to turn off buddies Toby and Holly, and select buddies Ben and Danny.

When the user clicks on button 37 it changes from saying “off” to indicating a “mood”. Thus, the user may move from the interface shown in FIG. 4(b) to that shown in FIG. 4(c) by clicking on the button 37, which causes the message “OFF” to be replaced by a face indicating an “inquisitive” mood. Clicking on button 37 again changes the mood from “inquisitive” to “intellectual”, as shown in FIG. 4(d). Thus, the button 37 allows the user to change the local property “mood” for each of the buddies which are active.

FIG. 4(e) shows how the browser window 34 may be triggered to permit the user to select the set of buddies which are displayed in area 35, and which the user can simply toggle on-and-off as shown in FIGS. 4(a) and 4(b). When thus triggered, the area 39 is displayed, showing for all the predefined buddies (35 of them are shown, from “Toby” to “Titus”) a respective icon. The user can toggle each icon in area 39 on or off, e.g. by clicking on the icon. An icon which is toggled on is shown with a darkened background in area 39, and a duplicate is placed in area 35.

The display 34 further includes a section 41 which the user can use to modify the attribute which is controlled by button 37. In section 41, four local attributes “age”, “race”, “mood”, and “gender” are given, and by clicking on the appropriate word the user modifies the function of the button 37 so as to control the possible settings of the corresponding attribute. For example, if the user clicks on the word “gender” then clicking on the button 37 subsequently will change the local attribute of gender between the two possibilities.

Turning to FIG. 4(f), the browser window 34 is shown as including a conventional region 43 for displaying data retrieved from a remote server, such as server 17. In this example the server 17 is accessed while the buddy Andrea is selected and the mood is “happy”. The attributes of Andrea have been set as follows:

Gender: Female

Age: 30s

Location: Europe

Interests: Health, Food

Mood: Happy

The server 17 is sent all of these attributes, and responds by returning to the user's device, for display in section 43 of the window 34, information selected to be relevant to the Andrea buddy: namely an article on health problems for Women (“health” and “female” being two of Andrea's attributes) and an article on “food”.

By contrast, as shown in FIG. 4(g), if the user connects to the server 17 after selecting the buddy Danny having the attributes:

Gender: Male

Location: Europe

Interests: Sport, Toys, Music, Socialising, Cosmology

Mood: Curious

then the server 17 returns different data to the user's device, and accordingly the display in section 43 of the window 34 is different, for example including information on the “toys” and “music” which are subject attributes of the buddy Danny.

Note that in neither of the cases shown in FIGS. 4(f) and 4(g) does the server necessarily operate based on ALL the attributes of the selected buddies; for example the server may only regard the “interests” attributes and neglect the “mood” attribute.

Although the invention has been explained above in relation to particular embodiments, many variations are possible within the scope of the invention as will be clear to a skilled person. For example, the invention may be used in combination with a speech recognition system, so that the user can specify which buddies should be enabled by a vocal command.

Furthermore, the invention can be used to modify interactions between a user and his own computer device, rather than to moderate interactions over a communication network. A first example would be in accessing data records within the user's computer device (even on a single hard drive, for example). If the number of files stored is very great (e.g. they may have been stored by more than one user), a search for files having relevance to a certain issue could be performed using a buddy protocol, with sets of computer resources within the computer being associated with respective buddies.

For example, a user, designer or controller of a computer system which controls or monitors a commercial process, such as a manufacturing or distribution process, may make use of buddies which respectively represent the “upstream” and/or “downstream” viewpoint of the process, so that he is able to investigate how the overall system is perceived from the point of view of an upstream or downstream colleague.

1. A method of a user accessing remote computing resources and of updating a profile relating to the resources, the method including:
selecting and receiving at least one profile from a plurality of predetermined anonymous profiles stored in a central database remote from the user, each profile being associated with at least one of a predefined set of remote computing resources and comprising means for enhanced interaction with the predefined and other resources, the predefined set of resources including at least one resource which has been determined by a control server;
selecting one of the predefined resources associated with at least one of the selected profiles; and
establishing communication with the selected resource for interaction with the same;
wherein the method further comprises:
modifying the interaction of the user with the predefined resource or any other resource using the enhanced interaction means;
receiving at the control server data relating to the user's use of the selected profile; and
updating the corresponding profile in the central database using the received data in combination with profile use data received from previous users of the same profile.

2. A method according to claim 1, wherein the method further comprises:
transmitting over a communication network, from a computer device operated by the user to a computing apparatus which defines the selected resource, an instruction to perform an action and profile data specifying which of the plurality of predetermined profiles was selected;
receiving at the computing apparatus the instruction and profile data;
using the received profile data to access a profile database of characteristics associated with each profile;
retrieving characteristics associated with the at least one profile selected by the user; and
operating the computer apparatus in accordance with the at least one selected profile.

3. A method according to claim 2, wherein the computing apparatus operating step comprises performing the instruction in accordance with the at least one selected profile.

4. A method according to claim 2, wherein the computing apparatus operating step comprises recording the at least one selected profile.

5. A method according to any of claims 2 to 4, wherein the profile database is associated with the computing apparatus and the method further comprises the computing apparatus accessing, via the communication network, a control database operated by the control server remote from the computing apparatus and updating the profile database.

6. A method according to any of claims 2 to 5, wherein the transmitting step comprises transmitting additional data selected by the user and associated with at least one of the selected profiles.

7. A method according to any of claims 2 to 6, wherein the computer device comprises a local database and the method further comprises storing, in the local database, a copy of the set of resources listed in the profile database and updating the local database from the central database.

8. A method according to any of claims 2 to 7, wherein the communication network is the World Wide Web.

9. A method according to any of claims 2 to 8, wherein the selecting and receiving step comprises the user selecting a plurality of profiles and assigning each of the selected profiles a respective weighting value, said profile data specifying the weighting values, and the method further comprises the computing apparatus performing the computing operation using the weighting values.

10. A method according to any preceding claim, wherein the selecting and receiving step comprises presenting, for each of said predetermined profiles, a respective icon, suggestive of at least one characteristic of the profile.

11. A method according to any preceding claim, wherein the method further comprises storing a record of at least one property of the selected resource and of the at least one selected profile and collating, at the control server, an accumulated plurality of said records to obtain profile characterisation information characterising at least one correlation between said selected profiles and said properties of the accessed resources.

12. A method according to claim 11, wherein the method further comprises the user inputting a judgement about the accessed resource, storing a record of the judgement and of the at least one selected profile of the user, and collating at the central server an accumulated plurality of said records to obtain information characterising at least one correlation between said judgements and said profiles.

13. A method of managing a plurality of predefined profiles, the method comprising:
storing in a first database, for each of the profiles, respective sets of data associated with the profiles, the respective sets of data defining one or more resources associated with the profiles;
receiving over a communication network and storing in a second database information characterising actions performed by a plurality of users at times when those users have selected one or more of the profiles;
collating the information in the second database to determine the statistical behaviour of the plurality of users who selected each profile; and
updating the data associated with each profile, based on the results of the collating step, thereby modifying the set of resources associated with the profiles.

14. A method according to any preceding claim, wherein each said profile is associated with at least one human characteristic.

15. A method according to claim 14, wherein said characteristics include any one or more of (i) an age-group characteristic, (ii) a lifestyle characteristic, (iii) an expertise characteristic, (iv) a leisure interest, (v) a personality characteristic, (vi) a mood, (vii) an appearance, (viii) a circumstance, or (ix) a gender.

16. A computer program product storing program instructions readable by a computer device to cause the computing apparatus to be operable to perform a method according to any preceding claim.

17. A control apparatus for connection to a communication network, the apparatus comprising:
a first database storing for each of a plurality of profiles a respective set of data associated with the profiles, each set of data defining a set of one or more resources associated with the profiles;
a second database for storing information received from the communication network, characterising actions performed by a plurality of users at times when a respective plurality of those users have selected each of the profiles; and
a processor for collating the information in the second database to determine the statistical behaviour of the plurality of users who selected each profile, and based on the results of the collation updating the data associated with each profile, whereby the processor modifies the set of resources associated with the profile.

18. An apparatus according to claim 17, wherein each profile is associated with at least one human characteristic.

19. An apparatus according to claim 18, wherein said characteristics include any one or more of (i) an age-group characteristic, (ii) a lifestyle characteristic, (iii) an expertise characteristic, (iv) a leisure interest, (v) a personality characteristic, (vi) a mood, (vii) an appearance, (viii) a circumstance, or (ix) a gender.

20. A system for assisting a user in accessing remote computing resources and for updating a profile relating to the resources, the system comprising:
a store comprising a predetermined set of remote computing resources;
a control server for determining at least one of the resources of the predetermined set;
a central database operable with the control server, the central database comprising a plurality of predetermined anonymous profiles, each profile being associated with at least one of the predetermined set of remote computing resources and comprising means for enhanced interaction with the predefined and other resources;
a user computing device remote from the central database, the user computing device being arranged to select and receive at least one profile from the plurality of predetermined profiles and to select one of the predefined resources associated with the at least one selected profile;
communication means for establishing communication between the user computing device and the selected resource; and
processing means for modifying the interaction of the user with the predefined resource, or any other resource, using the enhanced interaction means;
wherein the control server comprises:
input means for receiving data relating to the user's use of the selected profile; and
profile management means for updating the corresponding profile in the central database using the received data in combination with profile use data received from previous users of the same profile.
